(19) United States
(12) Patent Application Publication
(10) Pub. No.: US 2008/0303765 A1
(43) Pub. Date: Dec. 11, 2008

(54) Liquid crystal display device and driving method thereof

(75) Inventor: Hitoshi Nakatsuka, Osaka (JP)

Correspondence Address: Yokoi & Co.;U.S.A., Inc., #723, 13700 Marina Pointe Drive, Marina Del Rey, CA, 90292, US

(73) Assignee: Funai Electric Co., Ltd., Osaka (JP)

(21) Appl. No.: 12/156,285

(22) Filed: May 30, 2008

(30) Foreign Application Priority Data
Jun. 5, 2007 (JP) JP2007-149024

(51) Int. Cl. G09G 3/36

(52) U.S. Cl. 345/87

(57) ABSTRACT

In a liquid crystal display device, the TFT(i,j) is switched by a gate signal supplied from the gate driver 13 to supply the data signal to the pixels P(i,j). The gate driver 13 includes a charging waveform section with the electric charge lower than the threshold voltage to the TFT(i,j), a drive waveform section at the voltage higher than the threshold voltage, and a falling waveform section having the falling waveform modulated.

### CROSS-REFERENCES TO RELATED APPLICATIONS

The present application is related to the Japanese Patent Application No. 2007-149024, filed Jun. 5, 2007, the entire disclosure of which is expressly incorporated by reference herein.

### BACKGROUND OF THE INVENTION

1. Field of the Invention

The present invention relates to a liquid crystal display device and a method of driving the liquid crystal display device.

2. Description of the Related Art

Generally, the liquid crystal display device displays the image using the liquid crystal having the molecule arrangement variable with the voltage. Japanese Unexamined Patent Application Publication No. 2006-133406 discloses the liquid crystal display device which includes a panel formed of pixels filled with the liquid crystal, the source driver which supplies the data signal to the panel, and the gate driver which specifies the pixel array for supplying the data signal in the horizontal scan period.

In the aforementioned liquid crystal display device, the gate driver and the pixels are connected using the scan lines GL and the switching element. When the drive signal is output from the gate driver to the scan line GL, the switching element is turned ON to supply the data signal to the liquid crystal. The switching element is formed of the thin film transistor (TFT). When the drive signal is applied to the gate electrode, the TFT supplies the data signal applied to the source electrode to the liquid crystal connected to the drain electrode. At the aforementioned timing, the delay occurs both in the rise and fall of the drive signal as shown in FIG. 10, and accordingly, the period for charging the data signal to the liquid crystal becomes shorter than the predetermined period. In case of the rise delay, the period for charging the data becomes shorter than the predetermined period. Meanwhile, in case of the fall delay, the switching element might write the next data erroneously. The charging period herein denotes the time taken for supplying the data signal to the pixels. The drive signal delay is caused by the wiring capacity and resistance of the scan line through which the drive signal is transmitted.

The wiring capacity of the scan line GL is increased as the screen size becomes larger. When the screen size is increased to a certain degree, the delay in the drive signal on the liquid crystal pixels apart from the input side of the drive signal is no longer negligible. The scan line GL may be replaced with the equivalent circuit having the switching element set to R component and the pixel set to C component as shown in FIG. 10. The RC components increase as they move rightward on the drawing, and become maximum at the right end. The drive signal output to the scan line GL makes the waveform sluggish as it moves rightward, thus increasing both the rise delay and the fall delay.

Generally, the drive signal is supplied from both sides of the scan line to suppress the delay in the drive signal for the purpose of preventing the delay in the rise and fall of the drive signal as described above. As the drive signal is supplied from both sides of the scan line, the RC components on the scan line may be considered as being half. However, the gate drivers have to be provided at both sides of the scan line so as to supply the drive signals, thus increasing the cost.

Japanese Unexamined Patent Application Publication No. 2001-51252 discloses the liquid crystal display device using the drive mode which allows the scan line selectable over the plural consecutive scan periods. In the aforementioned device, the single horizontal scan period immediately after the polarity reversal of the voltage of the data signal is set to the dummy horizontal scan period, and the data signal with the same polarity as that of the selected scan line is applied to the pixel selected as the dummy horizontal scan period for providing the sufficient charging period.

In the aforementioned technique, the scan line selected as the dummy horizontal scan period may be preliminarily charged to increase the charging period to the pixel.

Japanese Unexamined Patent Application Publication No. 2006-201760 discloses the technique which is not intended to provide the sufficient time for supplying the image data to the pixels. However, the disclosed technique is structured to bring the gate output (output terminal) in the high-impedance state into the off voltage (VGL) state sequentially to prevent the power source and the gate output from being turned OFF simultaneously, thus suppressing the value of the current which flows through the scan line.

This makes it possible to prevent the scan line being damaged by suppressing overcurrent upon the power ON.

Japanese Unexamined Patent Application Publication No. 10-82980 discloses the technique which supplies the first selection voltage to the scan line, and then the second selection voltage with the different polarity from that of the first selection voltage to the scan line for the purpose of improving the display feature of the liquid crystal display device.

In the technique, the DC component of the voltage applied to the pixels may be suppressed to the minimum.

The art disclosed in the aforementioned Japanese Unexamined Patent Application Publication No. 2001-51252 has the problem as described below.

That is, the polarity of the data signal supplied to the pixel on the selected scan line and the pixel on the scan line selected in the dummy scan period has to be made the same for each pixel array, thus restricting the usable reverse mode.

Generally, the pixel reverse mode allows the single scan line or two scan lines to be selected simultaneously. In Japanese Unexamined Patent Application Publication No. 2001-51252, four scan lines may be selected simultaneously. So the number of pixels each having the same polarity on the selected scan lines is increased, which is likely to cause the block-like boundary unevenness on the screen.

The latch pulse which supplies the data signal to the source driver for each horizontal scan period is irregularly formed, thus demanding the complicated control.

Japanese Unexamined Patent Application Publication Nos. 2006-201760 and 10-82980 are not intended to solve the problem of the charging period, thus failing to solve the problem of the present invention.

### BRIEF SUMMARY OF THE INVENTION

The present invention discloses a liquid crystal display device capable of using a generally employed scan line drive method while providing the cost effectiveness, and the method for driving the liquid crystal display device.

The present invention provides a liquid crystal display device, including a display panel that forms a screen, plural scan lines, a switching element that is turned ON to supply a data signal to pixels that form the screen upon reception of a drive signal via the plural scan lines, and a drive signal supply section for supplying the drive signal to the scan lines in a horizontal scan period, the drive signal supply section supplies an electric charge lower than a threshold voltage of the switching element before a charging period for supplying the data signal to the pixels in the horizontal scan period, further supplies the drive signal at a voltage value higher than the threshold voltage to the switching element in the charging period of the horizontal scan period, and includes a waveform modulation section for sharpening a gradient of a falling waveform of the drive signal supplied to the pixels.

In the structure, the predetermined voltage is applied before the charging period, and then the drive signal at the higher voltage is supplied. As a result, the time taken for the drive signal to exceed the threshold voltage becomes short. The waveform modulation section modulates to sharpen the gradient of the falling waveform of the drive signal to reduce the time taken for the drive signal to be below the threshold voltage. This makes it possible to provide the charging period for the liquid crystal display region apart from the output section of the drive signal where it is difficult to provide the charging period.

The voltage is applied before the elapse of the charging period for the purpose of reducing the time taken for the switching element to exceed the threshold voltage, not for the purpose of charging the data signal to the liquid crystal. For this, the voltage value is set to be lower than the threshold voltage.

The drive signal does not have to be supplied from both sides of the scan line. The elimination of one gate driver may reduce the cost. The scan line of the liquid crystal display device, and the hardware structure such as the switching element do not have to be improved. The invention, thus may be used by improving the drive signal supply section (or gate driver). The generally employed liquid crystal display device may be improved at the lower cost.

In the invention, the time for the charge applied to the switching element to exceed the threshold voltage is reduced to improve the delay in the drive signal, thus providing the charging period. The present invention is structured to be independent from the polarity matrix of the pixel voltage, thus allowing the invention to be applied to the liquid crystal display device using the arbitrary reverse mode.

The drive signal supply section is not limited to such unit as the gate driver, but may be formed of the wiring mounted on the liquid crystal panel and the device for supplying the drive signal to the wiring.

The sharpening of the waveform gradient includes the rising of the waveform like the slope, or the falling of the waveform like the ramp.

In the structure, the period before the charging period is set as a first OE (Output buffer Enable) period for specifying a period of the drive signal, for which the switching element is not turned ON. The waveform modulation section sharpens a gradient of the waveform of the drive signal in a second OE period for specifying a falling period of the drive signal.

In the structure, the predetermined voltage is supplied to the switching element in the first OE period, and the drive signal is modulated in the second OE period. The OE period is set to prevent rewiring of the next data owing to the sluggish falling waveform of the gate signal. In particular, the first OE period is set for specifying the region where the switching element is not turned ON by the drive signal. The second OE period is set for specifying the falling region of the drive signal supplied to the scan line.

The present invention solves the problem of the delay in the rising and falling of the switching element using the period other than the charging period without reducing the existing charging period.

The structure includes a source driver for supplying the data signal to the pixels. The source driver includes a delay section for delaying supply of the data signal in accordance with a delay caused by sequential supply of the drive signal to the scan lines.

The data signal output from the source driver is delayed in accordance with the supply of the drive signal to provide the charging period. This makes it possible to reduce the delay even if the OE period is reduced, and to provide the charging period by the amount corresponding to the reduction in the OE period.

As the specific structure with the feature of the present invention, the drive signal supply section supplies the drive signal from one side of the scan line. The switching element is formed as the thin film transistor so as to be turned ON/OFF in accordance with the output of the first and the second OE signals output in the OE period.

The present invention provides not only the liquid crystal device but also the method with the technical features. That is, the invention provides a method for driving a liquid crystal display device provided with plural scan lines, a switching element that is turned ON to supply a data signal to pixels that form a screen, and a drive signal supply section for supplying the drive signal to the scan lines, comprising: supplying an electric charge lower than a threshold voltage of the switching element before a charging period of a horizontal scan period for supplying the data signal to the pixels; supplying the drive signal at a voltage higher than the threshold voltage to the switching element in the charging period of the horizontal scan period; and sharpening a gradient of a falling waveform of the drive signal.

These and other features, aspects, and advantages of the invention will be apparent to those skilled in the art from the following detailed description of preferred non-limiting exemplary embodiments, taken together with the drawings and the claims that follow.

### BRIEF DESCRIPTION OF THE DRAWINGS

It is to be understood that the drawings are to be used for the purposes of exemplary illustration only and not as a definition of the limits of the invention. Throughout the disclosure, the word “exemplary” is used exclusively to mean “serving as an example, instance, or illustration.” Any embodiment described as “exemplary” is not necessarily to be construed as preferred or advantageous over other embodiments.

Referring to the drawings in which like reference character(s) present corresponding parts throughout:

FIG. 1 is a block diagram of a liquid crystal display device as an example;

FIG. 2 shows waveforms of the liquid crystal display device as an example;

FIG. 3 is a block diagram of a gate driver as an example;

FIG. 4 shows a waveform representing a gate signal as an example;

FIG. 5 is a view showing the general-purpose gate driver used in the liquid crystal display device according to an example of the present invention;

FIG. 6 shows waveforms of the liquid crystal display device as an example;

FIG. 7 is a view representing the delay in the gate signal as an example;

FIG. 8 shows the relationship between the gate signal and the data signal in a modified example;

FIG. 9 is a block diagram of a gate driver in a modified example; and

FIG. 10 is a view showing the relationship between the conventional scan line and the gate signal.

### DETAILED DESCRIPTION OF THE INVENTION

An embodiment of the present invention will be described in the following sections.
(1) Structure of liquid crystal display device:
(2) Function/Effect of liquid crystal display device:
(3) Modified examples:
(4) Outline:

### (1) STRUCTURE OF LIQUID CRYSTAL DISPLAY DEVICE

In a liquid crystal display device according to the invention, a TFT (switching element) is turned ON by a gate signal (drive signal) supplied from a gate driver (drive signal supply section) to supply a data signal from a source driver to pixels. The gate driver according to the present invention supplies the charge lower than the threshold voltage which turns the TFT ON before the charging period in the horizontal scan period to a gate electrode of the TFT, and the gate signal set as the voltage value higher than the threshold voltage in the charging period to the gate electrode of the TFT. The gate driver functions in sharpening the falling waveform gradient of the gate signal (as the waveform modulation section). The amount of charge fed to the gate electrode of the TFT exceeds the threshold voltage at the earlier stage, and the charge becomes below the threshold voltage at the earlier stage as well. In the case where the gate signal is supplied to the scan line with the large wiring capacity, the delay in the gate signal at the pixel apart from the gate driver hardly occurs, thus providing the desired charging period to the pixel.

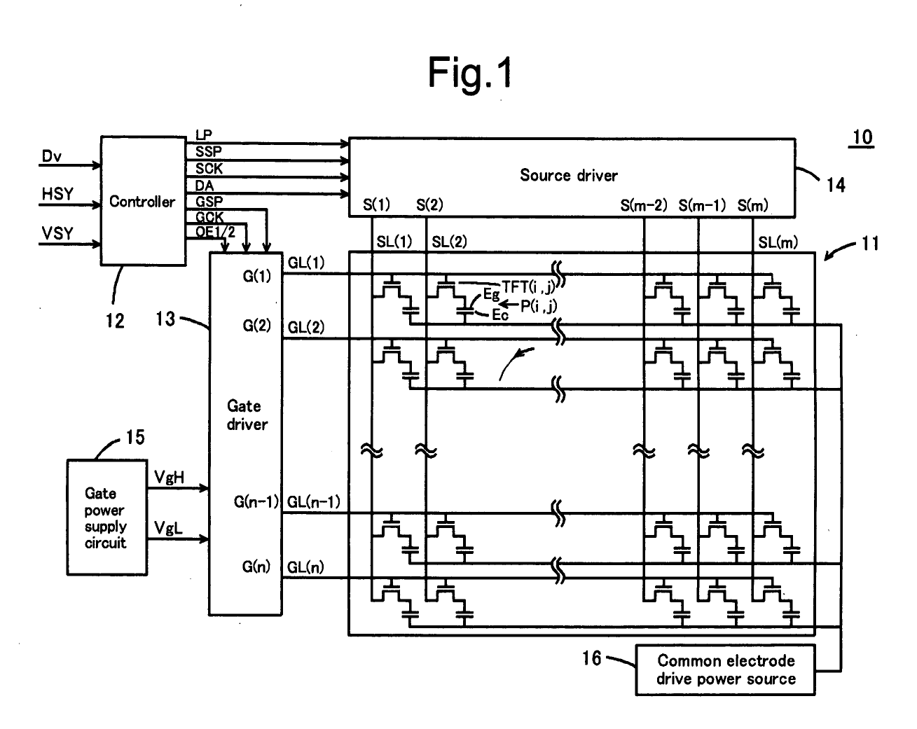

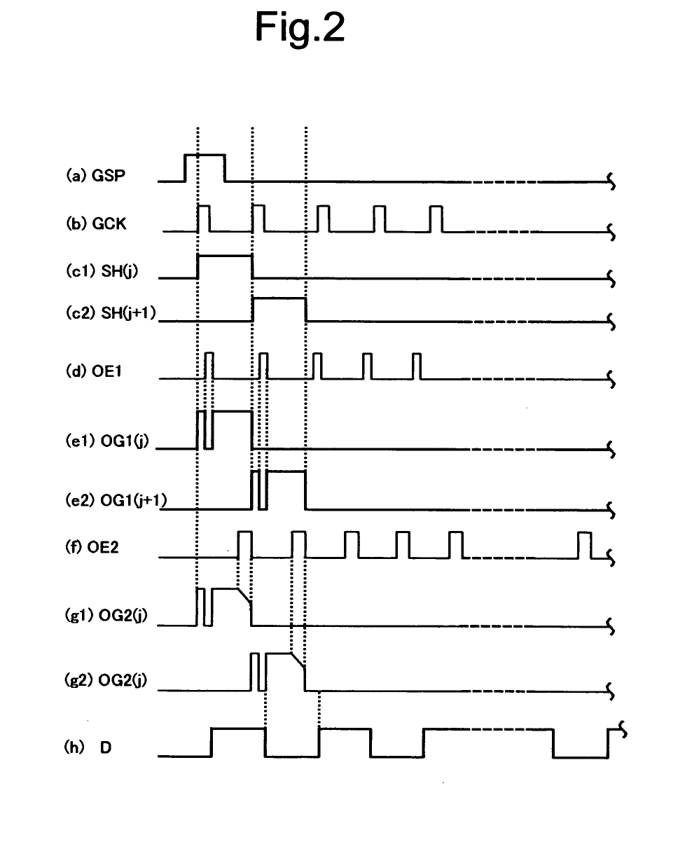

Referring to FIG. 1, a liquid crystal display device 10 includes a display section 11 with active matrix structure, a controller 12 for controlling the drive of the liquid crystal display device 10, a gate driver 13 (drive signal supply section) for outputting a gate signal, a source driver 14 for outputting a data signal, a gate power supply circuit 15 for supplying the signal voltage to the gate driver 13, and a common electrode drive power source 16 for supplying a common voltage to the display section 11. The operation for driving the liquid crystal display device 10 is controlled by the respective signals shown in FIG. 2. When the control signal is output to the controller 12 from a not shown main machine, the source driver 14 supplies the data signal ((h) in FIG. 2) to the TFT (i, j) under the control of the controller 12. The gate driver 13 supplies the gate signal ((g1) or (g2) in FIG. 2) to the gate electrode of the TFT (i,j) under the control of the controller 12. The TFT (i,j) applies the carrier current to the region between the source electrode and the drain electrode upon the input of the gate signal so as to supply the data signal from the source driver 14 to the pixel P (i,j). In this way, the pixel receives the predetermined electric charge.

The display section 11 includes plural scan lines GL (j), data lines SL (i) which intersect with the scan lines GL (j), the TFT (i,j) connected to the scan line GL (j) and the data line SL (i), and the pixel P (i,j) connected to the TFT (i,j)(i=1 to m, j=1 to n). The scan line GL(j) is connected to the output terminal G(j) of the gate driver 13, and the gate electrode of the TFT(i,j), respectively The data line SL(i) is connected to output terminals S(1) to S(n) of the source driver 14, and the source electrode of the TFT(i,j), respectively. The pixel P (i,j) is formed of a pixel electrode Eg connected to the drain electrode of the TFT (i,j), a common electrode Ec connected to the common electrode drive source 16, and the liquid crystal layer interposed between the pixel electrode Eg and the common electrode Ec.

The controller 12 receives the video signal and the sync signal from the main machine, and outputs the respective signals for controlling the source driver 14 and the gate driver 13. The controller 12 receives a digital video signal Dv indicating the image to be displayed, a horizontal sync signal HSY and a vertical sync signal VSY corresponding to the digital video signal Dv from the main machine. The controller 12 supplies a latch pulse LP, a source driver start signal SSP, a source driver clock signal SCK, and a digital image signal DA to the source driver 14 based on the received digital video signals Dv, HSY, and VSY The controller 12 supplies a gate driver start signal GSP ((a) in FIG. 2), the gate driver clock signal GCK ((b) in FIG. 2), a first OE signal OE1 ((d) in FIG. 2) and a second OE signal OE2 ((f) in FIG. 2) to the gate driver 13. The first OE signal OE1 is provided for specifying the region where the TFT (i,j) is not turned ON. The second OE signal OE2 of the gate signal is provided for specifying the region where the gate signal supplied to the scan line GL is falling.

The source driver 14 digital/analog converts the digital image signal DA to generate a data signal D ((h) in FIG. 2) based on the input timing with respect to the latch pulse LP, the source driver start signal SSP, and the source driver clock signal SCK. Upon reception of inputs of the source driver start signal SSP and the source driver clock signal SCK, the source driver 14 outputs the generated data signal D to an output terminal S (1). Thereafter, the data signal D is supplied to the output terminals S(1) to S(m) sequentially based on the input of the latch pulse LP. The data signal D is then sequentially output to the respective data lines SL(i). In this way, the source driver 14 supplies the data signal D to the source electrodes of the TFT (i,j).

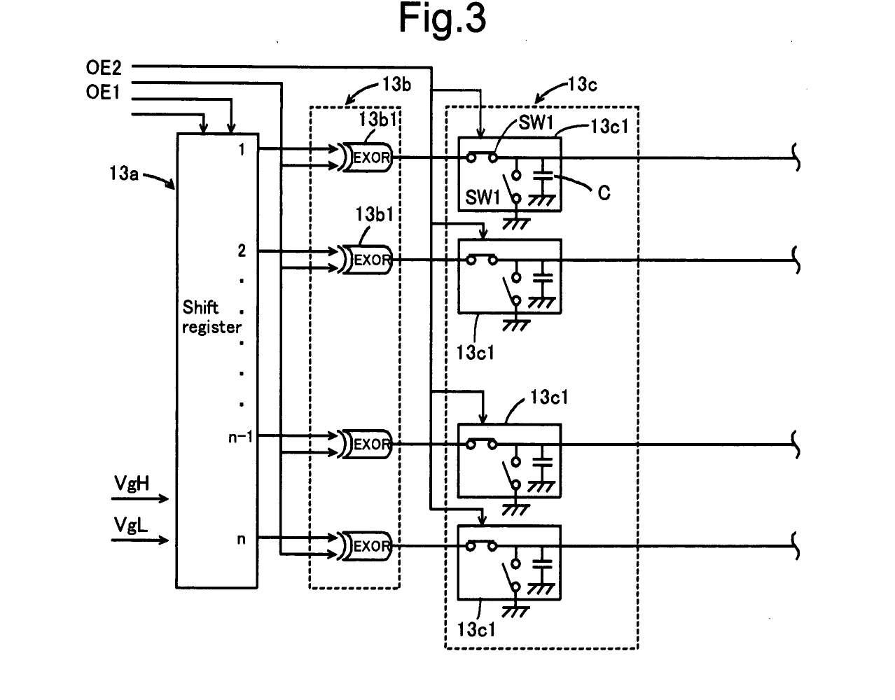

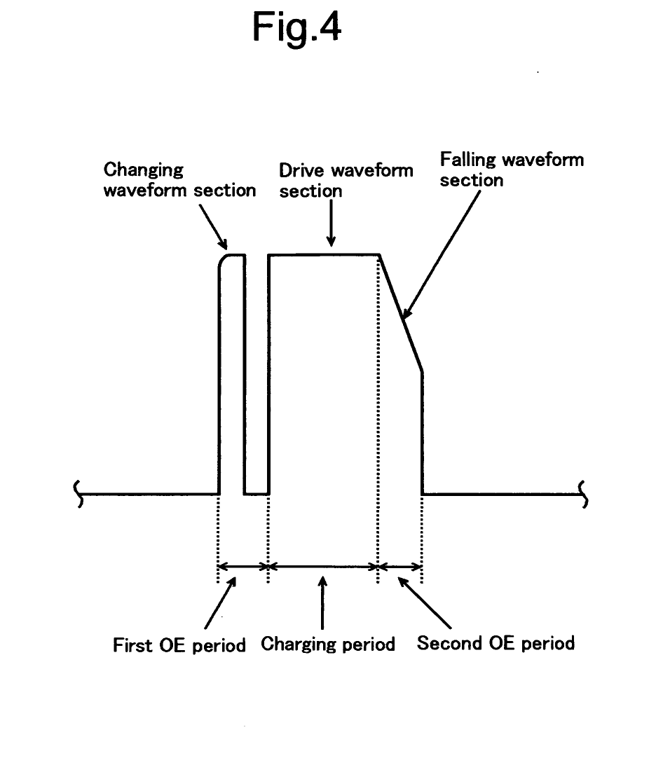

The gate driver 13 selects the scan line GL(j) sequentially based on the gate driver start signal GSP, the gate driver clock signal GCK, and the first and the second OE signal OE1 and OE2, and supplies the gate signal to the selected scan line GL(j). Referring to FIG. 3, the gate driver 13 includes a shift register 13a at nth stage, a pre-charge circuit 13b formed of n units of EXOR circuits 13b1, and a gate signal slope circuit 13c for modulating the waveform of the input signal. The gate driver 13 according to the present invention supplies the gate signal to the selected scan line GL(j) in the horizontal scan period including the first and the second OE periods and the charging period. The first OE period is set for specifying the period of the gate signal for which the TFT(i,j) is not turned ON. The second OE period is set for specifying the period for the fall of the gate signal. Referring to FIG. 4, the charging waveform section of the gate signal is applied in the first OE period, the drive waveform section is applied in the charging period, and the falling waveform section is applied in the second OE period.

The shift register. 13a generates a pulse signal SH(j)(j=1 to n) based on the gate voltages VgH and VgL supplied from the gate power supply circuit 15. Upon reception of the input of the gate driver start signal GSP and the gate driver clock signal GCK, the shift register 13a generates the pulse signal SH(j) corresponding to the length of time from the rising of the gate driver clock signal GCK to the next rising (that is, the length of the single horizontal scan period). The shift register 13a outputs the pulse signal SH(j) to the output terminal from G(1) to Gm sequentially corresponding to the gate driver clock signal GCK. That is, the shift register 13a outputs the high gate voltage VgH in the period from the rising of the gate driver clock signal GCK to the next rising.

The voltage value of the gate voltage VgH is higher than the threshold voltage of the gate electrode of the TFT (i,j). The structure may be designed in consideration with the threshold voltage of the gate electrode which varies depending on the material for forming the TFT to be used.

The pre-charge circuit 13b generates a first gate signal OG1 (see (e1) or (e2) in FIG. 2) including a charging waveform section for pre-charging the gate electrode and a drive waveform section for tuning the TFT (i,j) ON based on the pulse signal SH(j) and the first OE signal OE1. The pre-charge circuit 13b is formed of the first to the nth EXOR circuits 13b1. The jth EXOR circuit receives the input of the pulse signal SH(j) output from the output terminal at the jth stage of the shift register 13a. When the pulse signal SH(j) input through the EXOR calculation is in the level H, and the input first OE signal OE1 is in the level H, the EXOR circuit 13b1 at the jth stage outputs the signal in the level L. On the contrary, when the pulse signal SH(j) is in the level H, and the input first OE signal OE1 is in the level L, the j-th EXOR circuit 13b1 outputs the signal in the level H. As a result, the first gate signal OG1(j) is generated, which includes the charging waveform section which becomes the H level in the period from the rising of the pulse signal SH(j) to the timing when the first OE signal OE1 ((d) in FIG. 2) is kept in the L level, and the drive waveform section which becomes the H level during the period from the falling of the first OE signal OE1 to the falling of the pulse signal SH(j). The thus generated first gate signal OG1(j) is output to the gate signal slope circuit 13c.

The gate signal slope circuit 13c modulates the falling waveform of the first gate signal OG1(j) to generate the falling waveform section based on the second OE signal OE2 supplied from the controller 12. The gate signal slope circuit 13c is formed of n units of the waveform slope circuits 13c1. The waveform slope circuit 13c1 includes switching elements SW1 and SW2, and a capacitor C. The output terminal of the switching element SW2 is grounded. When the second OE signal OE2(f) is input to the waveform slope circuit 13c1, the contacts are switched between the switching elements SW1 and SW2 so as to be opposite with each other. Specifically, during the period when the second OE signal OE2(f) is in the H level, the switching element SW1 is grounded, and the switching element SW2 is electrically opened so as to charge the capacitor C. During the period when the second OE signal OE2(f) is in the L level, the switching element SW1 is electrically opened and the switching element SW2 is grounded to discharge the capacitor C. In this way, charging and discharging of the capacitor C is repeatedly performed to generate a second gate signal OG2(j) having the gradient of the falling waveform of the first gate signal OG1(j) sharpened. The thus generated second gate signal OG2(j) is output to the scan line GL(j) as the gate signal.

Another embodiment using the general-purpose gate driver will be described.

In the embodiment, the method for modulating the falling waveform of the gate signal in the second OE period is used to modulate the gate voltage VgH supplied from the gate power supply circuit 15 in the power source modulation circuit, and to supply the modulated signal to the gate driver 13. The power source modulation circuit modulates the gate voltage VgH based on the input of the second OE signal.

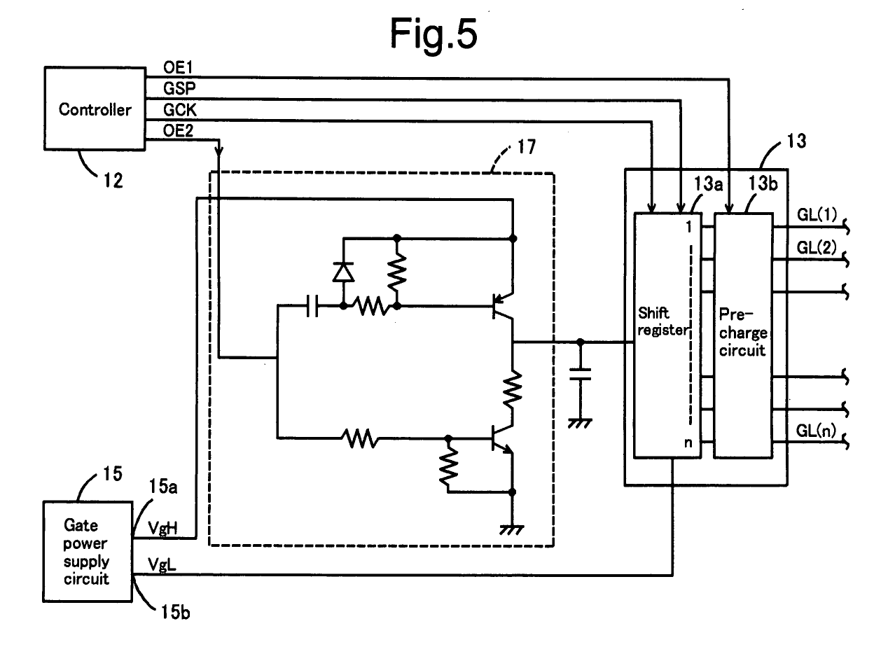

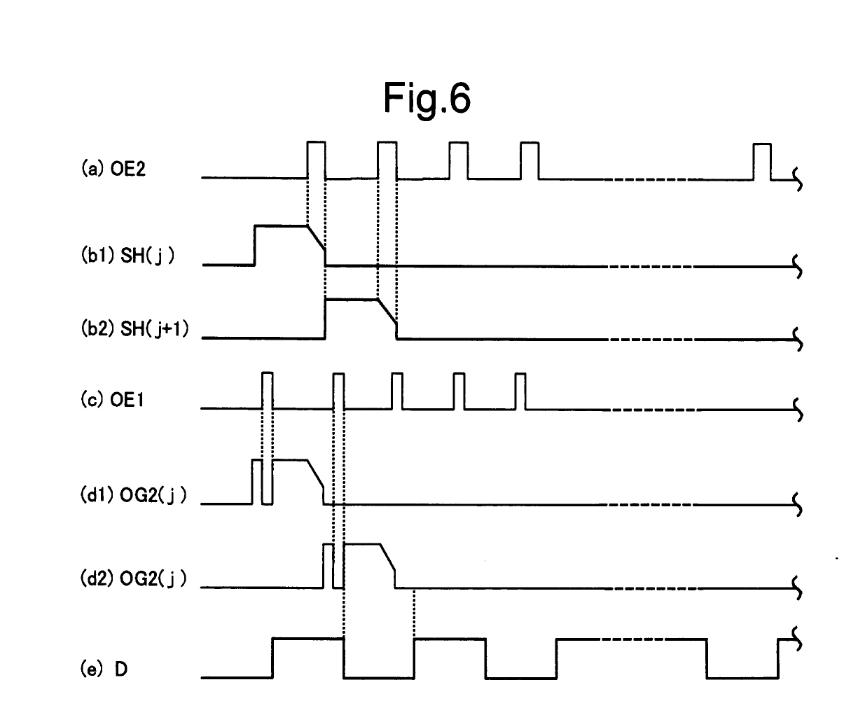

FIG. 5 shows the general-purpose gate driver employed in the liquid crystal display device according to the present invention. Referring to the drawing, a VgH output terminal 15a of the gate power supply circuit 15 is connected to a power source modulation circuit 17, and a VgL output terminal 15b is connected to the gate driver 13. The gate driver 13 includes the shift register 13a and the pre-charge circuit 13b, in the same way as in FIG. 3, and includes no gate signal slope circuit 13c. When the second OE signal as the slope signal is input to the power source modulation circuit 17, the power source modulation circuit modulates the waveform of the gate voltage VgH supplied from the gate power supply circuit 15 so as to be output to the shift register 13a. The respective output terminals G(1) to G(n) of the shift register 13a output the pulse signals SH(j) each having the falling waveform modulated ((b1) or (b2) in FIG. 6). Thereafter, the pre-charge circuit 13b generates the charging waveform section in the pulse signal SH(j) so as to be sequentially supplied to the scan lines GL(1) to GL(n) ((d1) or (d2) in FIG. 6).

### (2) FUNCTION/EFFECT OF LIQUID CRYSTAL DISPLAY DEVICE

A function of the liquid crystal display device according to the present invention will be described.

When the respective signals are supplied to the gate driver 13 from the controller 12, the gate driver 13 generates the second gate signal OG2(j). The generated second gate signal OG2(j) is applied to the gate electrode of the TFT (i,j) via the scan line GL(j) in the following order. First, the charging waveform section in the gate signal is applied to the gate electrode in the first OE period to perform charging at the voltage lower than the threshold voltage. Then, the drive waveform section is applied to the gate electrode to turn the TFT (i,j) ON by allowing the charging amount to exceed the threshold voltage such that the carrier current flows from the source electrode to the drain electrode. The pixel electrode Eg is charged by the amount corresponding to the data signal. Next, the falling waveform section is applied to the gate electrode in the second OE period, and after the elapse of the set period, discharging of the gate electrode is started. As a result, the charging amount of the gate electrode is decreased to be equal to or lower than the threshold voltage, and the TFT cuts the flow of the carrier current to stop charging the pixel electrode Eg.

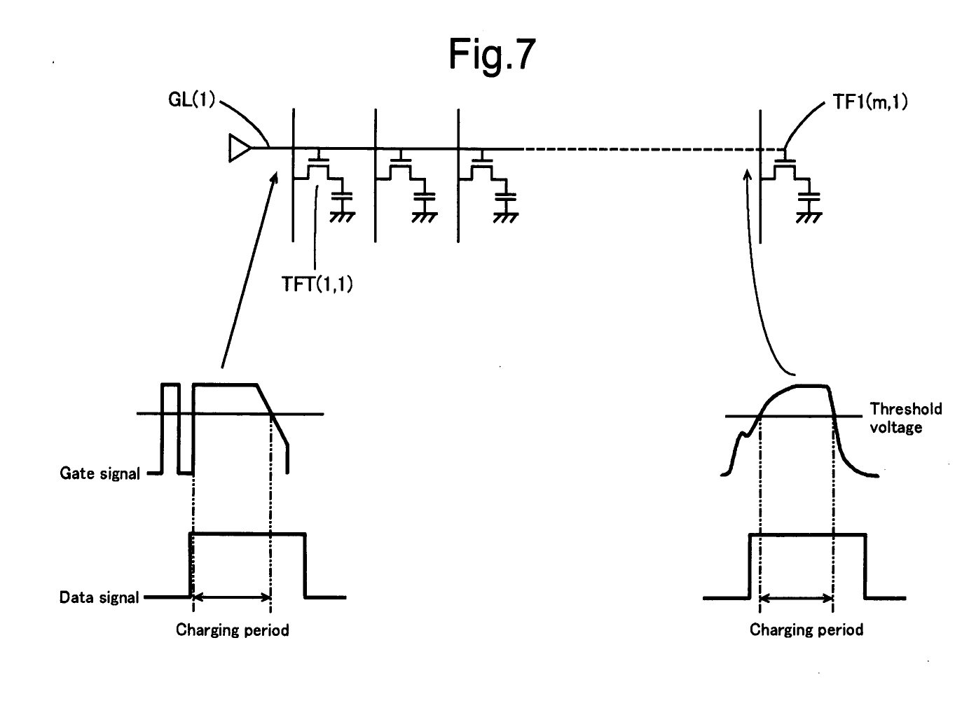

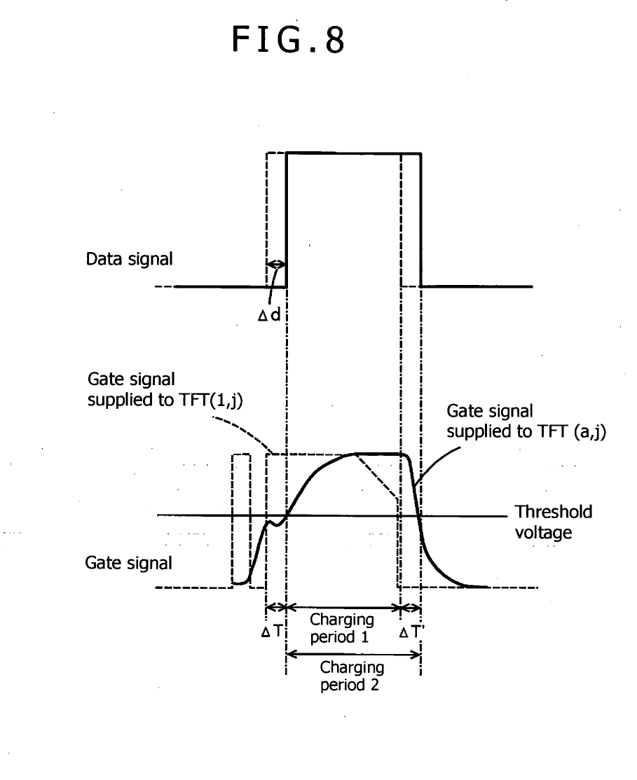

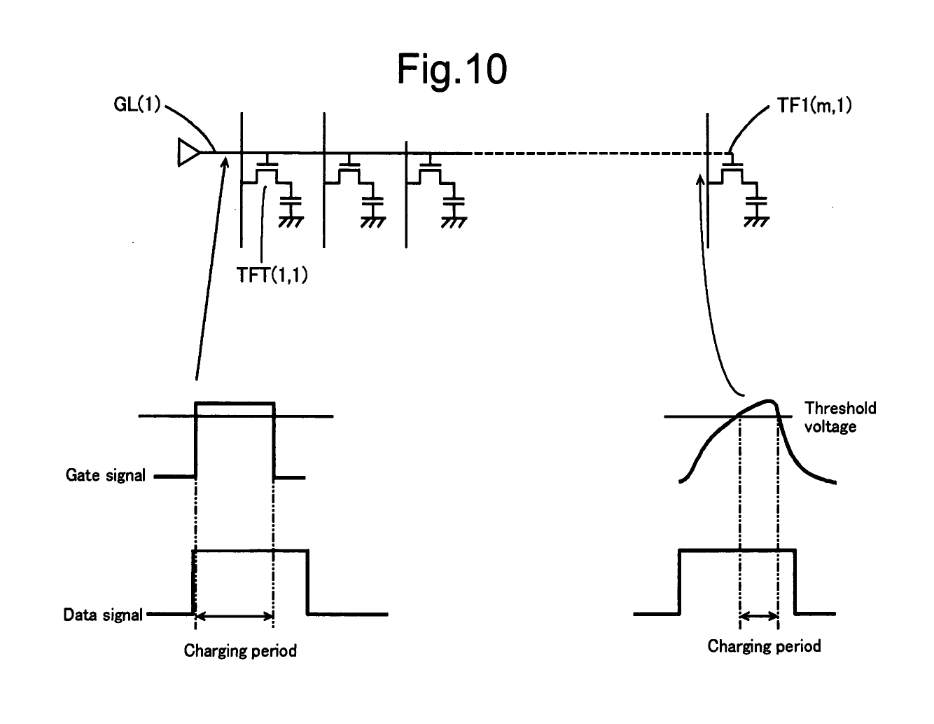

The liquid crystal display device 10 is capable of solving the insufficiency of the charging period in the liquid crystal region apart from the output section of the gate signal even if the gate signal is supplied from one side of the scan line GL(j) with the large wiring capacity. FIG. 7 shows the waveforms of the gate signals supplied to the TFT(1,1) and TFT(m,1) at both ends of the scan line GL(1) with the large wiring capacity according to the present invention. FIG. 10 shows the waveforms of the gate signals supplied to the TFT(1,1) and TFT(m,1) at both ends of the scan line GL(1) with the large wiring capacity in the generally employed liquid crystal display device. Referring to FIGS. 7 and 10, the gate signal supplied to the TFT(1,1) is regular in shape as it is hardly influenced by the wiring capacity of the scan line GL(1). Meanwhile, the gate signal supplied to the TFT(m,1) as shown in FIG. 10 is indistinct in shape as it is greatly influenced by the wiring capacity of the scan line GL(1). Referring to the gate signal supplied to the TFT(m,1) shown in FIG. 7, the charging waveform section has been preliminarily charged approximate to the threshold voltage, and the drive waveform section at the high voltage is applied to the gate electrode such that the time taken for the charging amount of the gate electrode to exceed the threshold voltage becomes short. As the gradient of the falling waveform of the gate signal is modulated, the time taken for the charge to be below the threshold voltage becomes shorter than the case as shown in FIG. 8. The liquid crystal display device 10 according to the present invention is capable of reducing the delay in the gate signal in the liquid crystal region apart from the output section of the gate signal irrespective of the large wiring capacity of the scan line GL(j). The liquid crystal display device using the scan line with the large wiring capacity is capable of supplying the gate signal from one side of the scan line, thus reducing the cost by the amount corresponding to the omitted gate driver.

The present invention may be used by improving the drive signal supply section (or the gate driver) with no need of modifying the scan lines of the display device and the hardware structure such as the switching elements. The modification to improve the generally employed display device may be made at the lower cost.

The liquid crystal display device according to the present invention further improves the charging period using the gate signal without depending on the polarity matrix of the pixel voltage, which is applicable to the liquid crystal display device using the arbitrary reverse mode.

### (3) MODIFIED EXAMPLES

Various modified examples of the liquid crystal display device according to the present invention may be provided.

The liquid crystal display device 10 is not limited to the structure having the gate driver as the module arranged on the side surface of the liquid crystal panel. That is, the structure having the circuit for outputting the gate signal mounted inside the glass substrate of the liquid crystal panel may be employed.

The clock signal generated by the gate driver 13 may be used for forming the charging/discharging waveform section and the falling waveform section in the gate signal instead of using the OE signal.

The structure having the output timing of the source signal of the source driver delayed in accordance with the delay time of the gate signal may be employed for providing the period for charging the pixel arranged at the end of the scan line. Referring to FIG. 8, when the gate signal supplied to the TFT (a,j) is delayed by ΔT with respect to the gate signal (shown by dashed line) supplied to the TFT (1,1), the rising time of the data signal is delayed by Δd to extend the charging period. With respect to the charging period 1 having no data signal delayed, the charging period 2 having the data signal delayed may be extended by ΔT′. This makes it possible to reduce the OE period to be shorter, thus providing further sufficient period for charging the pixel.

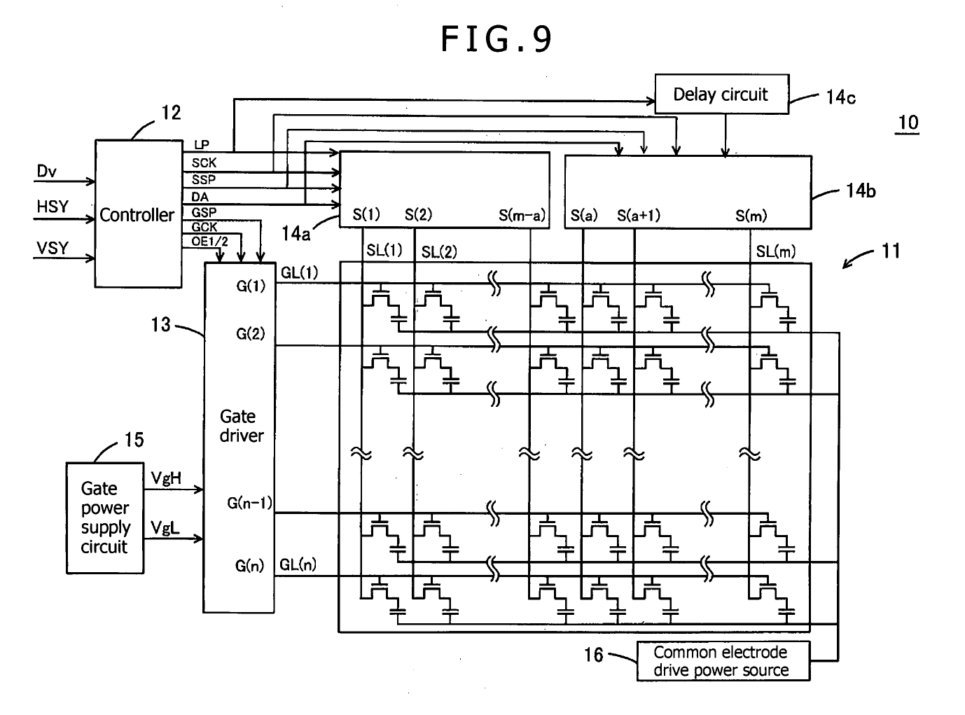

Referring to FIG. 9, the source driver 14 includes a first output section 14a for outputting a data signal to the data line SL(1) to SL(m-a) at the left side on the display section 11, a second output section 14b for outputting the data signal to the data lines SL(a) to SL(m) at the right side on the drawing, and a delay circuit 14c for delaying the output of the latch pulse LP to the second output section 14b. In the liquid crystal display device 10 according to the modified example, the delay circuit 14c delays the latch pulse LP to be output to the second output section 14b to delay the rise in the data signal.

The specific functions will be described hereinafter.

Pixels P(a,i) to P(m,i) to which the data signal is supplied from the second output section 14b are arranged to the right of the substantial center of the scan line GL(j). When the wiring capacity of the scan line GL(j) is large, the gate signal supplied to the pixel P(m,i) may be sluggish to cause the delay in the rising (i=1 to n). The latch pulse LP supplied to the second output section 14b is delayed in accordance with the gate signal to extend the charging period. Generally, the OE period is provided to alleviate the delay in the gate signal by specifying the period for which the TFT(i,j) is not turned ON with respect to the gate signal. So the delay in the data signal may alleviate the delay in the gate signal, thus reducing the OE period to be shorter.

In the aforementioned modified example, the source driver 14 is formed of the first output section 14a and the second output section 14b. However, the source driver 14 is not limited to the aforementioned structure. The number of the source drivers 14 may be set to 2 or more such that the output of the data signal of the respective source drivers may be delayed independently. The process for delaying the data signal is not limited to the one for delaying the latch pulse LP. Arbitrary process may be employed so long as the data signal is delayed.

### (4) OUTLINE

In the liquid crystal display device 10 according to the present invention, the TFT(i,j) is switched by the gate signal supplied from the gate driver 13 such that the data signal is supplied to the pixel P(i,j). In the present invention, the gate signal is formed of the charging waveform section for charging at the voltage lower than the threshold voltage with TFT(i,j), the drive waveform section set at the voltage value higher than the threshold voltage, and a falling waveform section with the shape of the falling gate signal at the sharp gradient. When the gate signal is supplied to the scan line with the large wiring capacity, the desired length of the period for charging the pixel P(i,j) is obtained without causing the delay.

It is to be understood that the present invention is not limited to the embodiment as described above, and that variances described below shall be considered as embodiments disclosed in the present invention.
A variance in which any of the members disclosed in one of the embodiments are appropriately combined with any of those disclosed in the other embodiments and exchangeable with the members.
A variance in which the members and structures disclosed in the embodiments are appropriately exchanged with those disclosed in related arts but not disclosed in the embodiments or appropriately combined with one another.
A variance in which the members and structures disclosed in the embodiments are appropriately exchanged with those thought to be substitutes by a person with ordinary skill in the art but not disclosed in the embodiments, and appropriately combined with one another.

While the invention has been particularly shown and described with respect to a preferred embodiment thereof, it should be understood by those skilled in the art that the foregoing and other changes in form and detail may be made therein without departing from the spirit and scope of the invention as defined in the appended claims.

Although the invention has been described in considerable detail in language specific to structural features and or method acts, it is to be understood that the invention defined in the appended claims is not necessarily limited to the specific features or acts described. Rather, the specific features and acts are disclosed as preferred forms of implementing the claimed invention. Therefore, while exemplary illustrative embodiments of the invention have been described, numerous variations and alternative embodiments will occur to those skilled in the art.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, proximal, distal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) is not used to show a serial or numerical limitation but instead is used to distinguish or identify the various members of the group.

What is claimed is:

1. A liquid crystal display device, including a display panel that forms a screen, plural scan lines, a switching element that is turned ON to supply a data signal to pixels that form the screen upon reception of a drive signal via the plural scan lines, and a drive signal supply section for supplying the drive signal to the scan lines in a horizontal scan period,
the drive signal supply section supplies an electric charge lower than a threshold voltage of the switching element before a charging period for supplying the data signal to the pixels in the horizontal scan period, further supplies the drive signal at a voltage value higher than the threshold voltage to the switching element in the charging period of the horizontal scan period, and includes a waveform modulation section for sharpening a gradient of a falling waveform of the drive signal supplied to the pixels.

2. The liquid crystal display device according to claim 1, wherein the drive signal supply section supplies the drive signal to the pixels from one side of the display panel via the scan line.

3. The liquid crystal display device according to claim 1, wherein:
the period before the charging period is set as a first OE (Output buffer Enable) period for specifying a period of the drive signal, for which the switching element is not turned ON; and
the waveform modulation section sharpens a gradient of the waveform of the drive signal in a second OE period for specifying a falling period of the drive signal.

4. The liquid crystal display device according to claim 1, further comprising a source driver for supplying the data signal to the pixels, wherein the source driver includes a delay section for delaying supply of the data signal in accordance with a delay caused by sequential supply of the drive signal to the scan lines.

5. The liquid crystal display device according to claim 3, wherein:
the switching element is a thin film transistor; and
the thin film transistor is switched ON and OFF based on output voltages of a first OE signal and a second OE signal output in the first and the second OE periods.

6. The liquid crystal display device according to claim 1, wherein:
the drive signal supply section supplies the drive signal to the pixels from one side of the display panel via the scan lines;
the period before the charging period is set as a first OE (Output buffer Enable) period for specifying a period of the drive signal, for which the switching element is not turned ON;
the waveform modulation section sharpens a gradient of the waveform of the drive signal in a second OE period for specifying a falling period of the drive signal;
the switching element is a thin film transistor;
the thin film transistor is switched ON and OFF based on output voltages of a first OE signal and a second OE signal output in the first and the second OE periods;
a source driver is provided for supplying the data signal to the pixels; and
the source driver includes a delay section for delaying supply of the data signal in accordance with a delay caused by sequential supply of the drive signal to the scan lines.

7. A method for driving a liquid crystal display device provided with plural scan lines, a switching element that is turned ON to supply a data signal to pixels that form a screen, and a drive signal supply section for supplying the drive signal to the scan lines, comprising:
supplying an electric charge lower than a threshold voltage of the switching element before a charging period of a horizontal scan period for supplying the data signal to the pixels;
supplying the drive signal at a voltage higher than the threshold voltage to the switching element in the charging period of the horizontal scan period; and
sharpening a gradient of a falling waveform of the drive signal.
